(19) United States
(12) Patent Application Publication
(10) Pub. No.: US 2026/0105573 A1
(43) Pub. Date: Apr. 16, 2026

(54) AUTOMATIC TESTS FOR VISUAL VALIDATION OF GENERATED IMAGES AND VIDEOS

(71) Applicant: NVIDIA Corporation, Santa Clara, CA (US)

(72) Inventor: Shreyas Bhausaheb Bhangare, Nashik (IN)

(73) Assignee: NVIDIA Corporation, Santa Clara, CA (US)

(21) Appl. No.: 18/913,202

(22) Filed: Oct. 11, 2024

(51) Int. Cl. G06T 5/50; G06V 10/44; G06V 10/82

(52) U.S. Cl. CPC G06T 5/50; G06V 10/44; G06V 10/82; G06T 2207/20221; G06V 2201/07

(57) ABSTRACT

Various examples, systems, and methods are disclosed relating to a visual modeling pipeline. A first computing system can receive, by a visual language model (VLM), visual data and a first prompt corresponding to a context of the visual data. The first computing system can determine, using the VLM and based at least in part on the visual data, at least one description of the visual data. The first computing system can determine a second prompt based at least in part on the at least one description. The first computing system can convert, using a large language model (LLM), the at least one description to a file format. The first computing system can use the at least one description in the file format for at least one automated test.

### BACKGROUND

Improving the accuracy of automated visual validation for image and video data presents challenges. Traditional methods often rely on reference-based comparisons, such as golden images, leading to inefficiencies and increased maintenance demands. This approach can result in frequent updates to reference images due to unpredictable or changing visual data. Challenges in maintaining these reference images under varying system conditions, such as changes in operating systems, drivers, or graphics processing unit (GPU) versions, create inefficiencies, affecting the accuracy and efficiency of validation in real-time or near real-time applications.

### SUMMARY

Implementations of the present disclosure relate to systems and methods for automated visual data validation using visual language models (VLMs) in conjunction with context-specific prompts. Systems and methods are disclosed that can use VLMs to analyze images or videos generated or captured during test execution by generating descriptive outputs that correspond to the context of the visual data. The VLM-based approach can determine whether the visual data meet predefined pass/fail criteria, reducing reliance on traditional techniques such as reference-based image comparison and deep learning models, which can encounter limitations with maintenance, interpretability, and sensitivity to input variations. The implementations can further enhance the accuracy and efficiency of visual validation by employing prompts that extract semantic content from visual data, enabling a more robust and scalable method for automated testing. For example, systems and methods in accordance with the present disclosure provide a framework for validating visual information by processing visual data through VLMs, generating structured outputs based at least in part on the context provided by customized prompts, and utilizing these outputs for automated decision-making in visual testing environments.

Some implementations relate to a system including one or more processors to execute one or more operations to obtain, by a visual language model (VLM), visual data and a first prompt corresponding to a context of the visual data. The one or more processors execute one or more operations to determine, using the VLM and based at least in part on the visual data, at least one description of the visual data. The one or more processors execute one or more operations to determine a second prompt based at least in part on the at least one description. The one or more processors execute one or more operations to convert, using a large language model (LLM), the at least one description to a file format. The one or more processors execute one or more operations to use the at least one description in the file format for at least one automated test.

In some implementations, the visual data includes at least one of (i) a generated image or video, (ii) a captured image or video, (iii) a composite image from a plurality of image sources, or (iv) a sequence of visual frames. In some implementations, the one or more operations to determine the second prompt is based at least in part on the at least one description and a skeletal JSON, and wherein the first prompt corresponds to a parameter of a visual testing framework corresponding to a feature or condition to test. In some implementations, the file format is JSON format, and wherein at least one description includes one or more attributes detected within the visual data, the one or more attributes including at least one of an object identification, a spatial orientation, or an environmental parameter.

In some implementations, the one or more operations further include at least one operation to receive, by the VLM, a subsequent prompt to validate the one or more attributes within the visual data. In some implementations, the one or more operations further include at least one operation to generate, by the VLM, a corresponding validation output. In some implementations, the corresponding validation output includes at least one of a pass-fail result, a confidence score, or an interpretation of the corresponding validation output, and wherein the subsequent prompt is structured to query the one or more attributes of the visual data.

In some implementations, the one or more operations to determine the at least one description of the visual data further includes extracting, by the VLM, the one or more attributes from the visual data using multimodal feature extraction corresponding with visual and textual elements based at least on in part on the first prompt. In some implementations, the one or more operations to convert using the LLM further includes mapping the one or more attributes of the at least one description into a structured data format compatible with a testing system.

Some implementations relate to one or more processors including one or more circuits to obtain, by at least one neural network (NN) model, visual data and a first prompt corresponding to a context of the visual data. The one or more circuits are to determine, using the at least one NN model and based at least on the first prompt, at least one description of the visual data. The one or more circuits are to determine a second prompt based at least in part on the at least one description. The one or more circuits are to generate, using the at least one NN model, a structured format for the at least one description. The one or more circuits are to use at least a portion of the structured format for at least one automated test associated with the visual data.

In some implementations, the visual data includes at least one of a generated image or video, a captured image or video, a composite image from a plurality of image sources, or a sequence of visual frames. In some implementations, the second prompt is determined based at least in part on the at least one description and a skeletal JSON, and wherein the first prompt corresponds to a parameter of a visual testing framework corresponding to a feature or condition to test. In some implementations, the structured format is JSON format, and wherein at least one description includes one or more attributes detected within the visual data, the one or more attributes including at least one of an object identification, a spatial orientation, or an environmental parameter.

In some implementations, the one or more processing circuits are to receive, by the at least one NN model, a subsequent prompt to validate the one or more attributes within the visual data. In some implementations, the one or more processing circuits are to generate, by the at least one NN model, a corresponding validation output. In some implementations, the corresponding validation output includes at least one of a pass-fail result, a confidence score, or an interpretation of the corresponding validation output, and wherein the subsequent prompt is structured to query the one or more attributes of the visual data.

In some implementations, determining the at least one description of the visual data further includes extracting, by the at least one NN model, the one or more attributes from the visual data using multimodal feature extraction corresponding with visual and textual elements based at least on in part on the first prompt. In some implementations, converting using the at least one NN model further includes mapping the one or more attributes of the at least one description into a structured data format compatible with a testing system.

Some implementations relate to a method. The method includes determining, using at least one neural network (NN) model and based at least in part on a first prompt corresponding to visual data, at least one description of the visual data. The method includes determining a second prompt based at least in part on the at least one description. The method includes converting, using the at least one NN model, the at least one description to a file format. The method includes applying at least a portion of the file format in at least one automated test associated with the visual data.

In some implementations, the visual data includes at least one of a generated image or video. In some implementations, a captured image or video, a composite image from a plurality of image sources, or a sequence of visual frames. In some implementations, the second prompt is determined based at least in part on the at least one description and a skeletal template, and wherein the first prompt corresponds to a parameter of a visual testing framework corresponding to a feature or condition to test.

The processors, systems, and/or methods described herein can be implemented by or included in at least one a system. The system can include a control system for an autonomous or semi-autonomous machine. The system can include a perception system for an autonomous or semi-autonomous machine. The system can include a system implemented using a robot. The system can include an aerial system. The system can include a medical system. The system can include a boating system. The system can include a smart area monitoring system. The system can include a system for performing deep learning operations. The system can include a system for performing simulation operations. The system can include a system for generating or presenting virtual reality (VR) content, augmented reality (AR) content, or mixed reality (MR) content. The system can include a system for performing digital twin operations. The system can include a system implemented using an edge device. The system can include a system incorporating one or more virtual machines (VMs). The system can include a system for generating synthetic data. The system can include a system implemented at least partially in a data center. The system can include a system for performing conversational artificial intelligence (AI) operations. The system can include a system for performing generative AI operations. The system can include a system implementing language models. The system can include a system implementing vision language models (VLMs). The system can include a system implementing large language models (LLMs). The system can include a system implementing small language models (SLMs). The system can include a system implementing small language models (SLMs). The system can include a system implementing multi-modal language models. The system can include a system for hosting one or more real-time streaming applications. The system can include a system for performing light transport simulation. The system can include a system for performing collaborative content creation for 3D assets. The system can include a system implemented at least partially using cloud computing resources.

### BRIEF DESCRIPTION OF THE DRAWINGS

The present systems and methods for visual validation of content using models are described in detail below with reference to the attached drawing figures, wherein:

FIG. 1 is a block diagram of an example of a system, in accordance with some implementations of the present disclosure;

FIG. 2 is a flow diagram of an example of a method for validating visual data using context-specific prompts and generating structured outputs in an example pipeline, in accordance with some implementations of the present disclosure;

FIG. 3 is a block diagram of the example pipeline, in accordance with some implementations of the present disclosure;

FIG. 4A is a block diagram of an example generative language model system for use in implementing at least some implementations of the present disclosure;

FIG. 4B is a block diagram of an example generative language model that includes a transformer encoder-decoder for use in implementing at least some implementations of the present disclosure;

FIG. 4C is a block diagram of an example generative language model that includes a decoder-only transformer architecture for use in implementing at least some implementations of the present disclosure;

FIG. 5 is a block diagram of an example computing device for use in implementing at least some implementations of the present disclosure; and

FIG. 6 is a block diagram of an example data center for use in implementing at least some implementations of the present disclosure.

### DETAILED DESCRIPTION

In automated tests, accuracy of generated and rendered images and videos are validated given the scenario that was executed in the tests. Although humans can easily validate accuracy of the images and/or videos rendered through subjective judgment, such validation remains an extremely challenging task for automation. Conventionally, golden images are reference images used for comparison in visual testing to provide a benchmark for accuracy. Validation based at least in part on reference-based comparison methods poses maintenance challenges as maintaining golden images requires substantial time and resources, especially when generated images and videos can be unpredictable and/or change frequently. The reference-based comparison methods also require constant updates to account for changes in operating systems, drivers, and/or graphics processing unit (GPU) versions, resulting in a significant maintenance overhead that can delay development processes. For example, techniques such as pixel-to-pixel comparison and structural similarity index which can be employed in reference-based comparison face similar challenges related to maintaining golden images.

Deep learning (DL)-based image classification models, such as convolutional neural networks (CNNs), process input images through layers of convolutions, pooling, and fully connected layers to extract features and make predictions based at least in part on labeled training data. The models learn from examples by adjusting weights to minimize loss and/or maximize gain. Such models require large, labeled training datasets and significant computational resources for training. The models can also struggle with overfitting, particularly on small datasets. Furthermore, the models can lack interpretability, making it difficult to understand their decision-making process. Additionally, DL models can be sensitive to input data variations and adversarial attacks, affecting robustness and generalizability of the system.

This disclosure relates to systems, methods, and non-transitory computer-readable media for performing automatic tests for visual validation of visual data (e.g., images and videos) to better match with the manner in which humans validate visual data, including using prompts corresponding to the context of the visual data and determining, using a visual language model (VLM) whether the visual data is accurate based at least in part on the prompts. In some implementations, a pass/fail decision can be generated by the VLM for a test that require visual validation of visual data generated and/or captured during test execution. For example, a VLM interrogates visual data with customized prompts and determines whether the visual data meet pass/fail criteria. Different from traditional methods such as like golden (reference-based) image comparison, scoring, and DL-based classification models, the VLM-based methods described herein improve the efficiency in terms of both time and cost given that the VLM-based methods described herein do not require training a model with a large dataset of labeled dataset.

Systems and methods in accordance with the present disclosure can improve visual data validation by facilitating automated assessment of visual accuracy while reducing and/or eliminating manual intervention and/or reference-based comparisons. For example, the use of VLMs for generating context-specific prompts and descriptions provides a dynamic and scalable framework to validate image and/or video content under varying conditions, minimizing and/or reducing updates to reference images and/or the retraining of models with large, labeled datasets. Additionally, the technical solution can reduce computational resources and time required for validation by using the VLM interpretations, rather than using computationally intensive deep learning models that can exhibit constraints with overfitting or input variability. The implementations can further improve robustness against changes in visual data attributes, such as different lighting conditions or object positions, by employing prompts of semantic content (e.g., not pixel-level comparisons). For example, the system can analyze whether an object is present or correctly rendered based at least in part on the context provided in the prompt, even if the visual appearance differs from prior examples.

The systems and methods described herein can be used for a variety of purposes, such as automated validation of visual content, analyzing the accuracy of visual rendering in graphics applications, verifying compliance of visual data with expected outcomes in testing environments, detecting visual defects in generated media, and/or assessing consistency of rendered content across multiple hardware configurations. These methods can improve automated testing efficiency by reducing the dependency on large, annotated datasets and allowing more precise, context-driven validation of visual information that aligns with human interpretative capabilities.

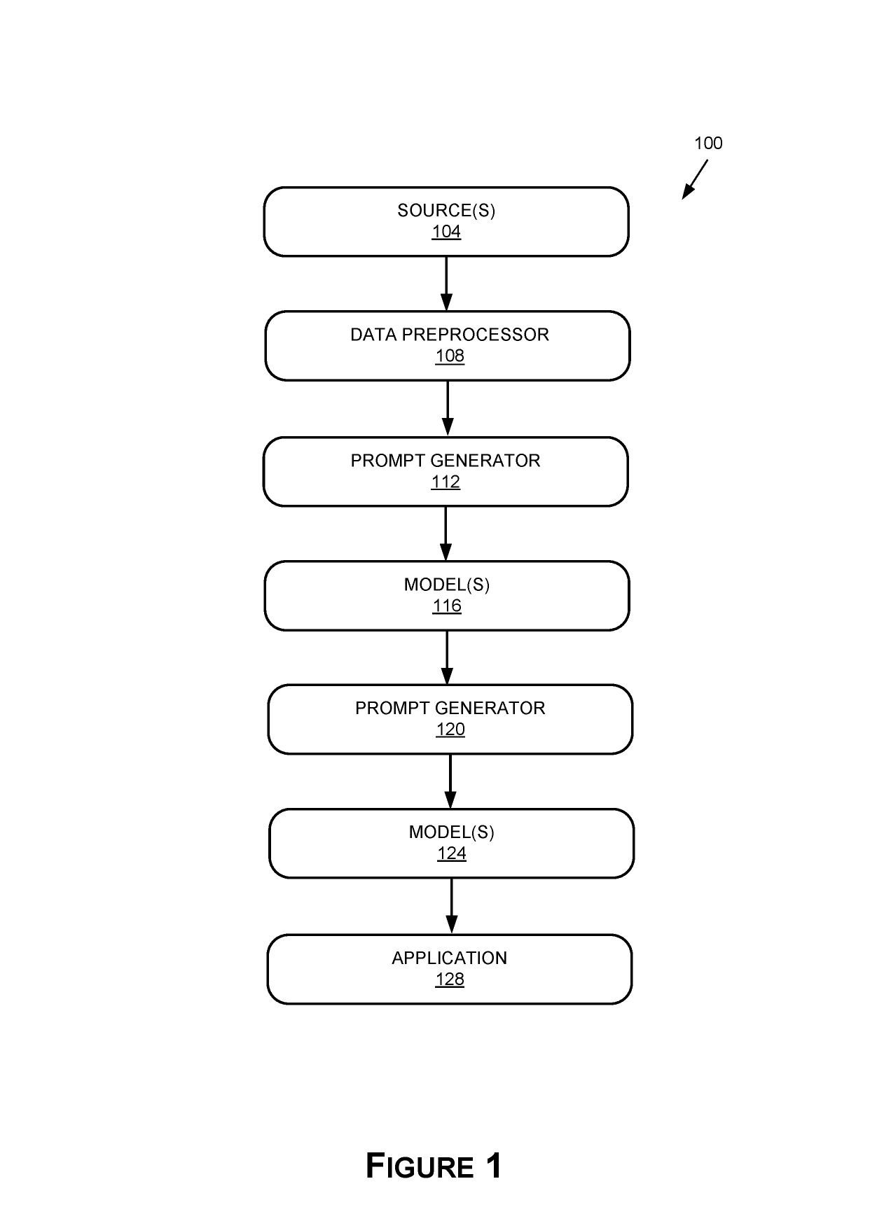

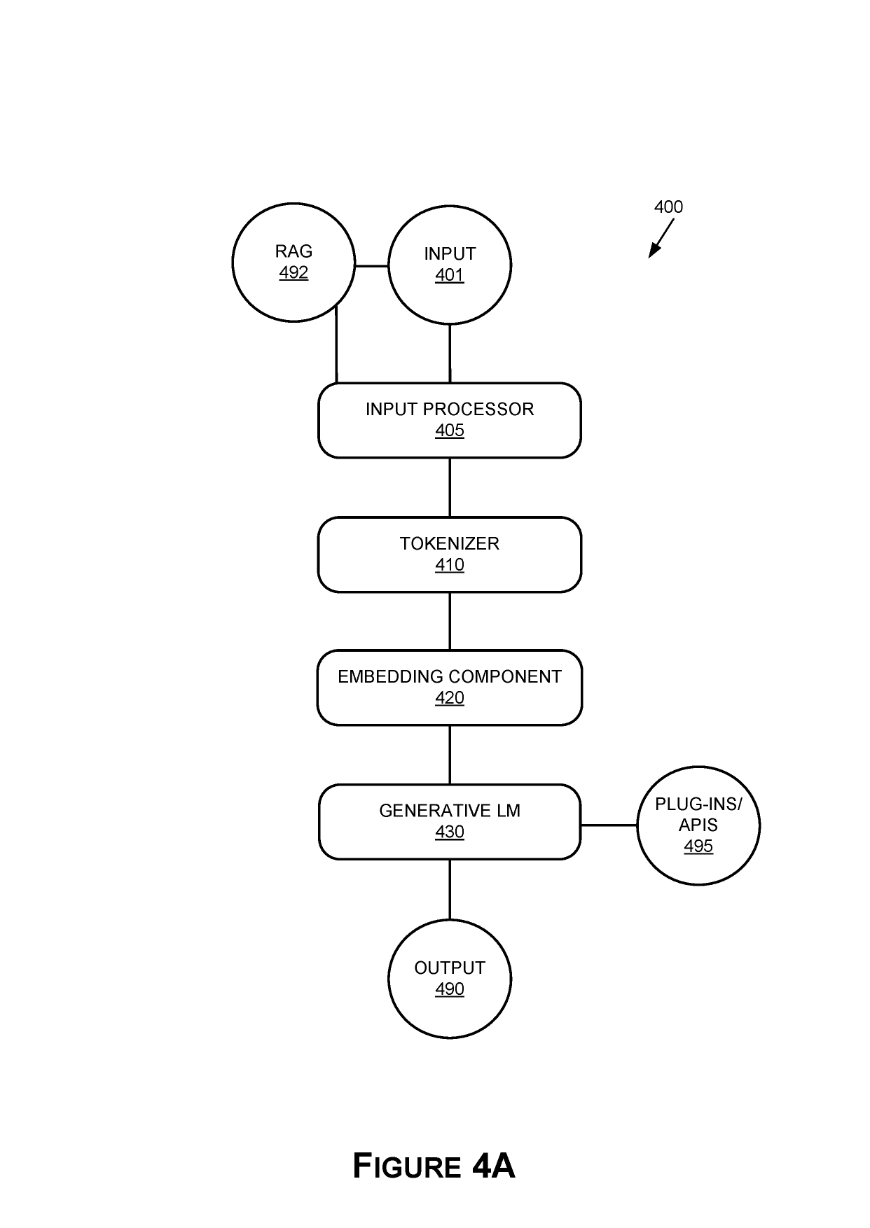

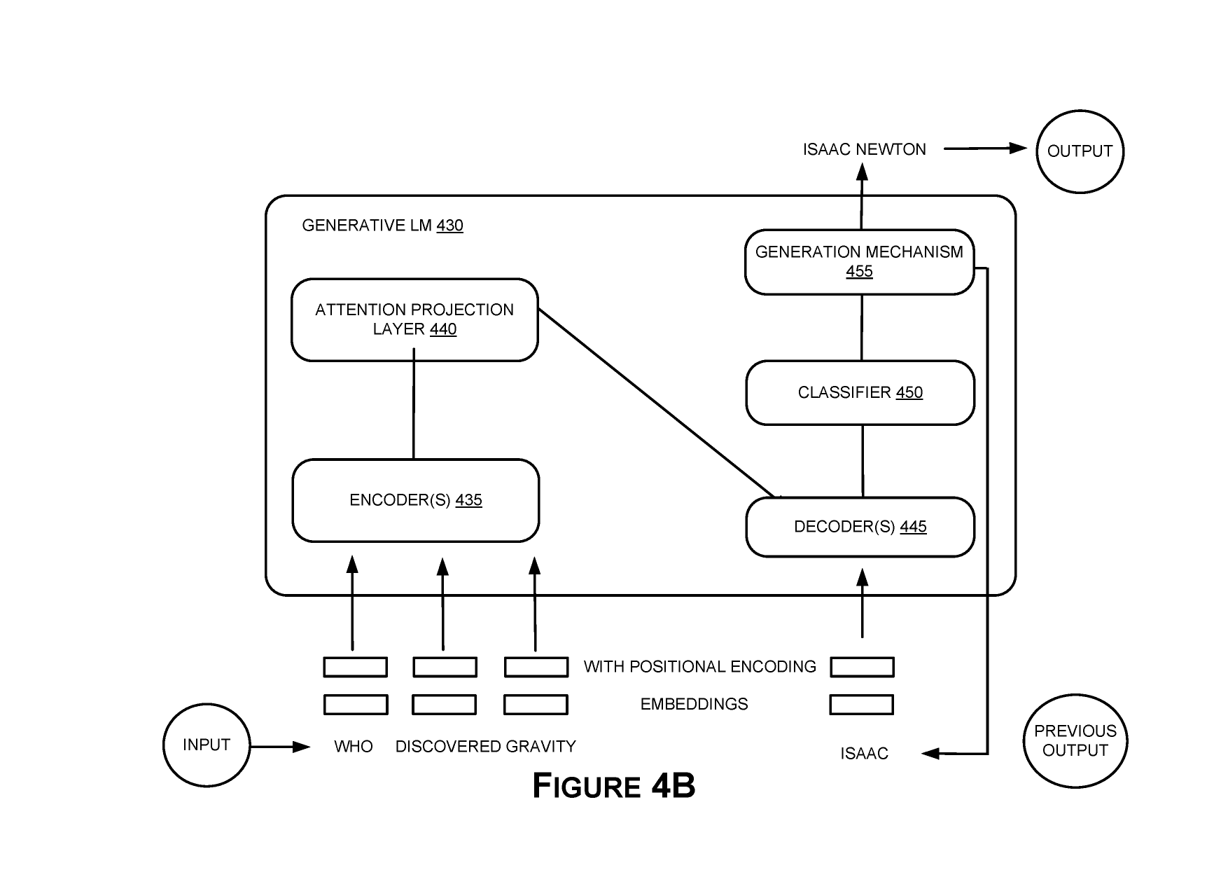

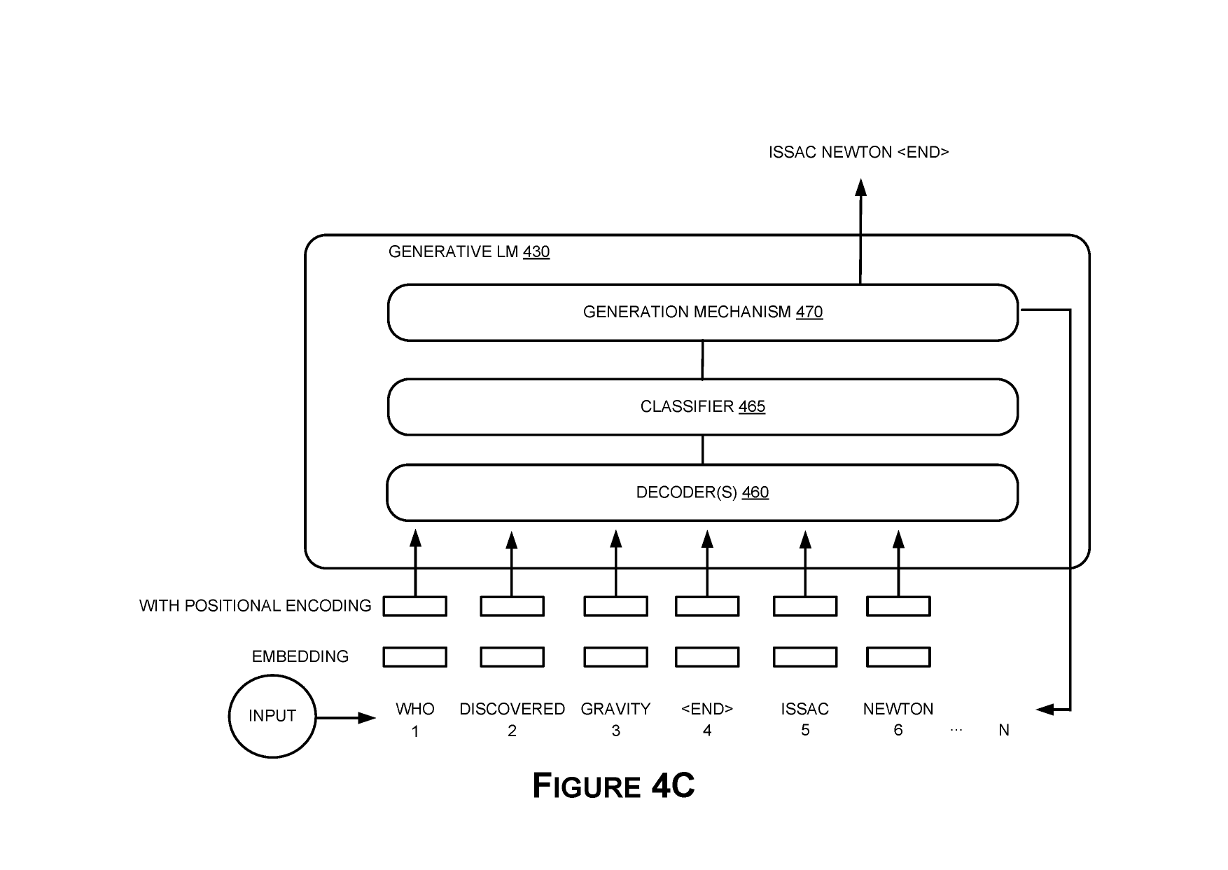

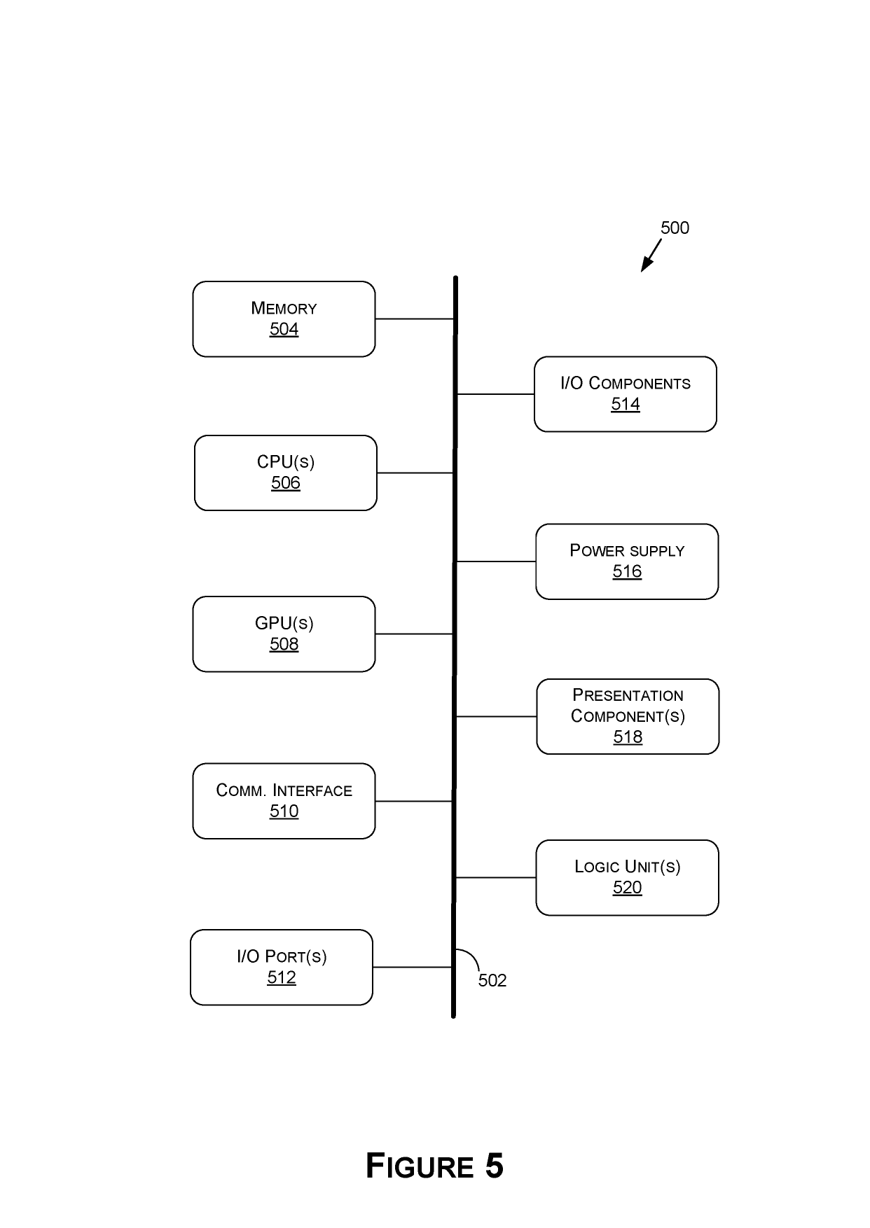

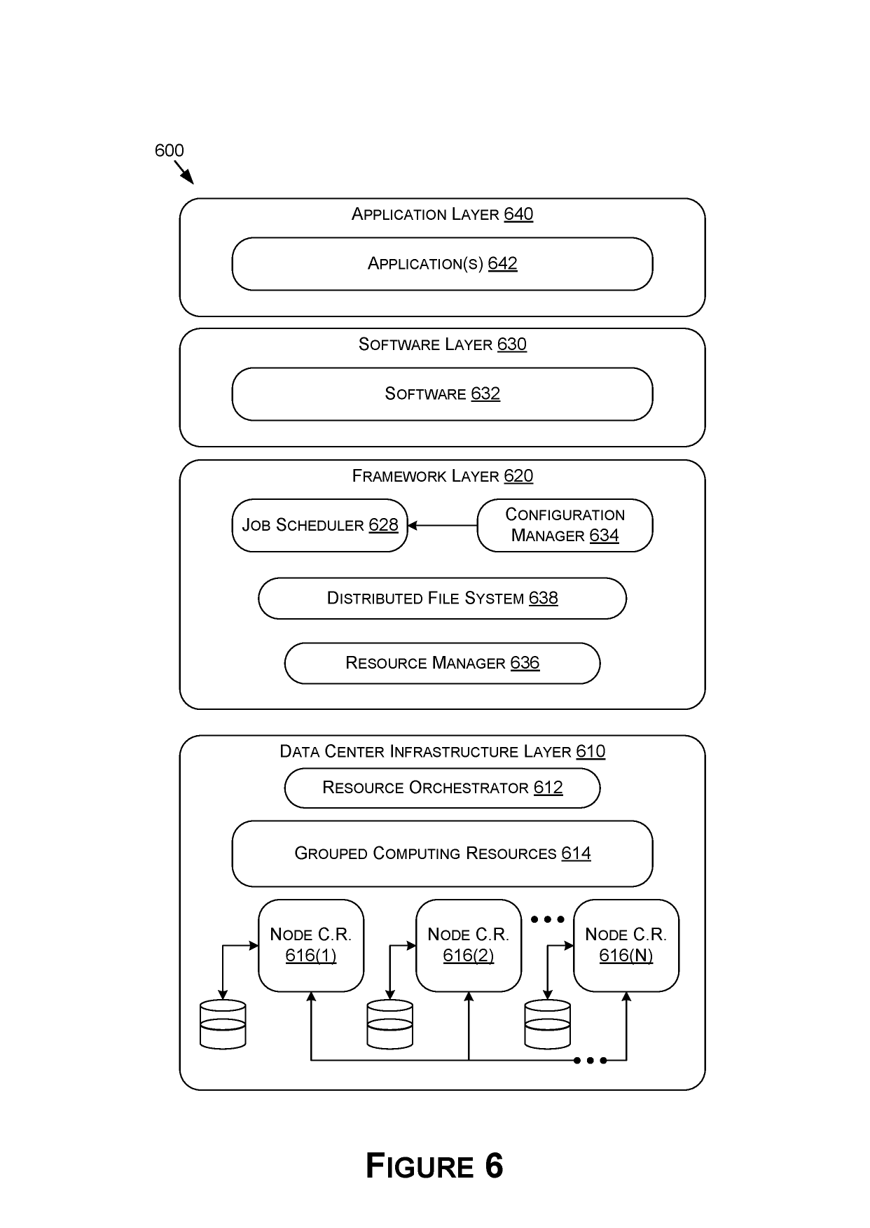

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 400 of FIG. 4A, example generative LM 430 of FIGS. 4B-4C, example computing device 500 of FIG. 5, and/or example data center 600 of FIG. 6.

The system 100 can implement at least a portion of a visual validation, prompt-based analysis, and/or structured data generation pipeline. For example, the system 100 can use one or more visual language models (VLMs) to analyze images or videos to generate descriptive outputs and evaluate the visual content based at least in part on context-specific prompts. The system 100 can be used to perform automated image validation, video content verification, and/or contextual visual assessment by any of various systems described herein, including but not limited to automated testing systems, graphics rendering systems, quality assurance systems, content generation systems, visual compliance systems, and/or data processing systems.

Generally, the visual modeling pipeline can include operations performed by the system 100. For example, the visual modeling pipeline can include any one or more of a preprocessing stage, a first prompt generation stage, a first modeling stage, a second prompt generation stage, a second modeling stage, and/or a testing stage.

The system 100 (e.g., implementing the visual modeling pipeline) can process visual data (e.g., images or videos) and generate contextual descriptions based at least in part on a first prompt. Additionally, the system 100 can generate a second prompt (e.g., a refined query or instruction) based at least in part on the initial visual data descriptions to further analyze one or more attributes or scenarios. In some implementations, the system 100 can convert these descriptions (e.g., visual features and associated text) into a structured file format, such as JSON, XML, YAML, CSV, or the like, using an LLM for use in automated testing or evaluation systems. Thus, the visual modeling pipeline can improve the accuracy and efficiency of visual data validation by reducing the usage of large, labeled datasets and improving interpretability using context-driven prompts and structured outputs.

The system 100 can include at least one data preprocessor 108. In some implementations, the preprocessing stage can refer to the stage in the visual modeling pipeline in which the data preprocessor 108 can identify and/or receive (or obtain) visual data. The data preprocessor 108 can receive and/or obtain visual data from source 104. For example, the visual data can include at least one of a generated image or video, a captured image or video, a composite image from a plurality of image sources, and/or a sequence of visual frames. The visual data can be captured during test execution. For example, the visual data can include recorded video sequences of a software application or graphical interface during automated testing to evaluate rendering accuracy and feature integrity. The source 104 can be a local testing device, a remote server, a cloud-based storage system, an automated test suite, or any data acquisition system.

In some implementations, the source 104 can be configured to transmit or stream visual data to the data preprocessor 108 for analysis. The data preprocessor 108 can include an application programming interface (API) and/or a data extraction system for preprocessing and structuring the visual data prior to analysis by the VLMs. That is, the data preprocessor 108 can communicate with the source 104 by sending data requests, receiving data streams, and/or accessing stored datasets, or any network communication protocols. In some implementations, the API of the data preprocessor 108 can augment, limit and/or filter visual data based at least in part on predefined constraints or requirements. For example, size limits (e.g., 10 megabytes, 1 gigabyte, 5 gigabytes), data format constraints (e.g., JPEG, PNG, MP4, AVI), resolution parameters (e.g., 1080p, 4K), and/or frame rate thresholds (e.g., 30fps, 60fps) can be enforced by the data preprocessor 108 to ensure compatibility and efficient processing. In this example, the data preprocessor 108 verifies that relevant and processable visual data is provided to the subsequent stages of the visual modeling pipeline.

In some implementations, receiving or obtaining the visual data can include the data preprocessor 108 initiating a data acquisition process based at least in part on a test execution schedule or an external request. For example, the source 104 can upload visual data generated during a test scenario to the data preprocessor 108 for modeling. In this example, the data preprocessor 108 can process and/or store the visual data in a structured repository for further processing by the VLMs (e.g., model 116). Additionally, the data preprocessor 108 can upload and/or store the visual data in a data storage system or database for retrieval and indexing. During uploading and/or storing, the data preprocessor 108 can generate and assign an identifier (e.g., asset ID), an upload URL, and/or other metadata (e.g., timestamp, test case ID, data source) to the visual data and/or portions of the visual data. For example, the data preprocessor 108 can categorize the visual data based at least in part on test scenario or image content. In this example, the data preprocessor 108 can create a metadata index to facilitate querying and retrieval for subsequent stages of the pipeline.

The system 100 can include at least one prompt generator 112. In some implementations, the first prompt generation stage can refer to the stage in the visual modeling pipeline in which the prompt generator 112 can obtain, generate, and/or determine a first prompt corresponding to a context (e.g., testing scenario, user interface element, visual effect, environmental condition, or any attribute) of the visual data. For example, the context can be a visual validation test checking whether specific elements, such as objects or effects, are accurately represented in the visual data according to the expected scenario. In this example, the first prompt can be structured to query the presence or accuracy of specific elements, such as “Are all navigation buttons visible and correctly labeled?”. That is, the prompt generator 112 can generate context-specific queries to focus the analysis of the VLM on relevant visual attributes. For example, the prompt can state “Is there fog present in the scene?”. In this example, the VLM (e.g., model 116) can assess environmental features to confirm the presence of fog or related visual effects. In some implementations, the first prompt can correspond to a parameter (e.g., UI element visibility, color accuracy, object presence, alignment, and/or any other test parameter) of a visual testing framework corresponding to a feature or condition to test. That is, the visual testing framework can be configured to validate specific visual properties. For example, a visual testing framework can be employed to analyze the integrity of visual transitions, responsiveness of interactive elements, color consistency, rendering speed, and/or any other visual performance metric.

Additionally, the feature or condition to test can be any predefined visual characteristic or behavior expected and/or estimated in the rendered content. For example, a feature to test can be the presence of a correctly rendered shadow effect under a virtual object. In another example, a condition to test can be the absence of visual tearing during rapid scene transitions. That is, the parameter can be any aspect and/or characteristic of the visual data that can be validated in a context. In some implementations, the prompt generator 112 can generate the first prompt such that the VLM focuses on the most critical attributes of the visual data for the current test scenario. For example, the prompt generator 112 can structure the query to focus the VLM on specific elements (e.g., text legibility, object alignment, etc.).

The system 100 can include at least one model 116. In some implementations, the first modeling stage can refer to the stage in the visual modeling pipeline in which the model 116 can determine at least one description of visual data based at least in part on the visual data and the first prompt. In some implementations, the model 116 can input the visual data (e.g., images or video) and a context-specific prompt to guide at least one visual language model (VLM) (e.g., Neva, Llava, Kosmos-2, Mixtral, EvalAI, and/or any other VLM compatible with the system architecture) in understanding the scenario to be validated. That is, the VLM (model 116) can be used to analyze (or model) the visual data to generate a descriptive output that captures relevant features (e.g., object detection, text recognition, spatial relationships, or any relevant scene attributes) or attributes (e.g., color distribution, geometric consistency, motion trajectory, or any contextual parameter) of the visual data.

In some implementations, the description generated by the model 116 can include one or more attributes detected within the visual data. For example, the one or more attributes can include at least one of an object identification (e.g., detected object types, object labels, object instances, and/or any object metadata), a spatial orientation (e.g., position coordinates, rotation angles, spatial arrangement, and/or any spatial data points), or an environmental parameter (e.g., lighting conditions, background elements, atmospheric effects, and/or any environmental factors). In this example, the attribute in the description can be used to provide a semantic representation of the visual data for analysis. The model 116 can detect the attribute within the visual data by applying feature extraction (e.g., object detection using bounding boxes, segmentation masks for isolating regions of interest, feature point mapping for spatial alignment) and multimodal analysis techniques (e.g., contextual embeddings for integrating visual and textual data, cross-modal attention mechanisms for correlating features, encoder-decoder architectures for generating descriptive outputs). That is, the model 116 can use visual and contextual information to generate a description (e.g., descriptive output) and/or a structure format for the description. For example, the model 116 can identify and describe elements within a scene, such as objects, background features, or environmental conditions, based at least in part on the initial prompt context and visual data.

In some implementations, the model 116 can extract one or more attributes from the visual data (e.g., using transformers, attention mechanisms, and/or other machine learning techniques) corresponding with visual and textual elements based at least in part on the first prompt. That is, the first prompt can guide the model 116 to focus on particular features or patterns in the visual data that are relevant to or used in testing. The visual elements can be low-level features such as edges, colors, and textures, or high-level features such as object shapes, spatial layouts, and scene structures. For example, the model 116 can extract features representing a shape, a texture, and/or a position. The textual elements can be descriptive annotations, contextual metadata, or any labels associated with the visual data. For example, textual elements can include captions describing the purpose of a visual test or tags indicating expected behaviors in a scene. The extracting can include applying multimodal fusion (e.g., attention-based integration, cross-modal embeddings, context-aware feature aggregation) to combine visual and textual data representations to generate unified model output describing the relationship between detected visual features and corresponding textual descriptions. For example, model 116 can generate a description of a scene or object, based at least in part on both visual inputs and prompt-driven contextual information.

In some implementations, the model 116 can maintain, execute, train, and/or update one or more machine-learning models while performing the first modeling stage. In some implementations, the machine-learning model(s) can include any type of deep learning model capable of processing visual and textual data to generate context-aware descriptions and/or a structured format of the context-aware descriptions based at least in part on structured prompts. For example, the machine-learning model(s) can be trained and/or updated to improve accuracy in detecting and describing visual scenarios, such as identifying elements under varying conditions. The machine-learning model(s) can be or include a visual-based model (e.g., vision transformers (ViT), attention-based models, capsule networks), a transformer-based model (e.g., a generative pre-trained/updated transformer (GPT) model), and/or any graph neural network (GNN) for modeling spatial relationships in visual data. The machine-learning model(s) can be or include a variational autoencoder (VAE) model, in some implementations. The model 116 can execute the machine-learning model (e.g., large language model (LLM)) to generate outputs (e.g., text descriptions, feature vectors, structured summaries). The model 116 can receive data to provide as input to the machine-learning model(s), which can include raw visual data, prompt information, and/or contextual metadata.

The model 116 can include any one or more artificial intelligence models (e.g., machine learning models, supervised models, neural network models, deep neural network models), rules, heuristics, algorithms, filters (e.g., Kalman filters), functions, or various combinations thereof to perform operations including attribute detection, data fusion, and/or semantic interpretation, such as object recognition, spatial analysis, and/or multimodal data integration. In some implementations, the model 116 can be trained/updated independently from other systems or devices described herein (e.g., model 124). In some implementations, training of the at least one model 116 can be at least partially performed jointly with the training of the model 124. In some implementations, the model 116 can output contextual descriptions (e.g., feature reports, scenario-specific summaries, and/or confidence scores). For example, the model 116 can determine (e.g., output) a structured representation of detected visual elements. For example, the model 116 can generate a semantic map of the visual data, indicating the presence and attributes of specific elements based at least in part on the initial prompt. In some implementations, the description (e.g., visual features, contextual metadata, scenario-specific attributes) can be provided to the other systems or devices described herein. That is, the description outputted by model 116 can be used to determine a second prompt (e.g., by prompt generator 120). For example, model 116 can provide the descriptions in a file format to the application 128 for subsequent automated analysis or validation. For example, to generate a second prompt, the prompt generator 120 can use the initial descriptions to formulate a query that directs the second model to convert the descriptive data into a structured format based at least in part on a predefined template, indicating specific attributes and corresponding values.

In some implementations, the model 116 can receive and/or obtain a subsequent prompt to validate the one or more attributes within the visual data. The subsequent prompt can be structured to query the one or more attributes of the visual data. That is, attributes of the visual data can include object characteristics, spatial configurations, visual effects, UI element properties, and/or any contextual features relevant to the validation scenario. For example, model 116 can verify the presence of an object, its position within the scene, and whether it matches the expected description provided in the prompt. In another example, model 116 can analyze the accuracy of lighting effects in a virtual scene based at least in part on specified criteria. In some implementations, the prompt generator 112 can receive and/or obtain (e.g., during testing, post-processing analysis, and/or interactive validation) feedback from the system or user to refine the prompt based at least in part on initial validation results. In this example, model 116 can generate a corresponding validation output. In some implementations, the validation output includes at least one of a pass-fail result, a confidence score, or an interpretation of the corresponding validation output. That is, the validation output can be a binary decision indicating the success or failure of the test, a probability-based confidence measure of the detected attributes, or a qualitative description of the observed discrepancies.

Additionally, the model 116 can output the validation output based at least in part on the alignment between detected attributes and the expected visual criteria defined by the prompt. The validation can be of the details of the visual content or scenarios. The visual content can be static images, video sequences, UI layouts, and/or any rendered visual media. The scenarios can be user interface testing, visual effect validation, content consistency checks, and/or any automated testing context. For example, the validation output can be a report summarizing the analysis of visual data attributes and corresponding validation results. In another example, the validation output can be a structured file containing annotated descriptions of detected features.

The system 100 can include at least one prompt generator 120. In some implementations, the second prompt generation stage can refer to the stage in the visual modeling pipeline in which the prompt generator 120 can generate and/or determine a second prompt based at least in part on the description. The prompt generator 120 can include similar features and functionalities as prompt generator 112. For example, the second prompt can state “Utilizing the provided information, generate a JSON indicating explicitly provided details in the description. Populate the sample JSON {‘fog’, ‘SenseOfDepth’} and furnish a valid JSON. Assign a value of False if information regarding the property is not explicitly provided.”. In this example, the prompt generator 120 structures the query to extract attributes from the initial descriptions and convert them into a structured format. In some implementations, the second prompt can be determined based at least in part on the at least one description and a skeletal JSON (or any other structured data template). For example, the initial visual descriptions can be used by prompt generator 120 to generate a second prompt to facilitate the generation of a structured output (e.g., satisfying a structured template). The structured output can be a JSON file, an XML schema, a CSV table, and/or any machine-readable format.

The system 100 can include at least one model 124. In some implementations, the second modeling stage can refer to the stage in the visual modeling pipeline in which the model 124 can convert the description to a file format (e.g., JSON format). That is, the model 124 can transform the generated description into a structured format (e.g., JSON, XML, YAML, Protobuf, and/or any data serialization format). The description in the file format can be used in subsequent automated testing (e.g., by application 128). In some implementations, converting can include the model 124 mapping the one or more attributes of the at least one description into a structured data format compatible with a testing system (e.g., application 128). That is, the model 124 structures the data according to a predefined schema to facilitate compatibility with downstream processing systems. For example, mapping can include assigning attribute values to corresponding keys in a JSON object, translating visual data features into structured data and/or creating a hierarchical data structure that represents visual information. In this example, the model 124 can generate a structured representation of the descriptive output of the visual data.

In some implementations, the model 124 can maintain, execute, train, and/or update one or more machine-learning models while performing the second modeling stage. In some implementations, the machine-learning model(s) can include any type of transformer-based model capable of converting visual descriptions into structured data formats based at least in part on multimodal inputs. That is, the input can be multimodal (e.g., visual and textual) such that the model can map visual features to structured representations. For example, the machine-learning model(s) can be trained and/or updated to improve the mapping accuracy between visual data attributes and corresponding structured representations. The machine-learning model(s) can be or include a large language model (LLM) (e.g., GPT, BERT, T5, and/or any other LLM), a transformer-based model (e.g., a generative pre-trained/updated transformer (GPT) model), a convolutional neural network (CNN), a recurrent neural network (RNN), or any graph neural network (GNN) for modeling data relationships. The machine-learning model(s) can be or include a variational autoencoder (VAE) model, in some implementations. The model 124 can execute the machine-learning model (e.g., large language model (LLM)) to generate outputs (e.g., structured data files, transformation logs, verification reports). The model 124 can receive data to provide as input to the machine-learning model(s), which can include preprocessed visual data, initial prompt descriptions, and/or intermediate model outputs.

The model 124 can include any one or more artificial intelligence models (e.g., machine learning models, supervised models, neural network models, deep neural network models), rules, heuristics, algorithms, filters (e.g., Kalman filters), functions, or various combinations thereof to perform operations including data transformation, semantic mapping, and/or format validation, such as converting visual data into structured formats. In some implementations, the model 124 can be trained/updated independently from other systems or devices described herein (e.g., model 116). In some implementations, training of the at least one model 124 can be at least partially performed jointly with the training of the model 116. In some implementations, the model 124 can output structured data representations (e.g., JSON files, XML schemas, formatted tables). For example, the model 124 can convert visual descriptions into a hierarchical JSON structure representing detected features and attributes. For example, the model 124 can map detected UI elements and corresponding properties into a structured format for automated analysis and reporting.

In some implementations, the descriptions in a file format (e.g., JSON, XML, YAML) can be provided to the other systems or devices described herein. That is, the model 124 can be configured to interface with testing applications or data storage systems for automated test execution and data retrieval. For example, model 124 can provide the descriptions in the file format to the application 128 for automated testing or data validation workflows. For example, to perform the automated test, the application 128 can verify the file format such that the structured data conforms to expected schemas and is compatible with testing protocols. That is, the resulting JSON can be used as the basis for making a PASS/FAIL, attribute verification, performance analysis, and/or any other determination for a test. For example, the application 128 can use the structured JSON to verify the presence and accuracy of visual elements during automated testing.

The system 100 can include or be coupled with at least one application 128. In some implementations, the testing stage can refer to the stage in the visual modeling pipeline in which the application 128 can use the description in the file format for at least one automated test. For example, the application 128 can apply at least a portion of the file format in at least one automated test associated with the visual data. In another example, the application 128 can use at least a portion of the structured format for at least one automated test associated with the visual data. That is, at least one application 128 can execute a series of validation checks based at least in part on the structured data provided by model 124 and generate testing outcomes accordingly. For example, the application 128 can facilitate the analysis of visual data attributes against predefined testing criteria. In some implementations, the application 128 can function as a test execution engine or data validation system. That is, the application 128 can perform automated validation of visual data elements against specified requirements or conditions. For example, the application 128 can use structured descriptions to verify the presence, position, and accuracy of UI elements or visual features in rendered content. In this example, the application 128 can generate a report indicating the results of each test case.

Additionally, the application 128 can perform automated regression testing, visual performance benchmarking, and/or compliance verification based at least in part on the structured data inputs. In some implementations, the application 128 can provide feedback or updates to other components of the system 100 based at least in part on the test results. That is, the application 128 can communicate with data preprocessors, prompt generators, and modeling stages to update the validation process. For example, the application 128 can initiate additional tests or revalidation cycles based at least in part on the outcomes of the automated tests. In another example, the application 128 can update testing criteria or modify prompts based at least in part on new requirements.

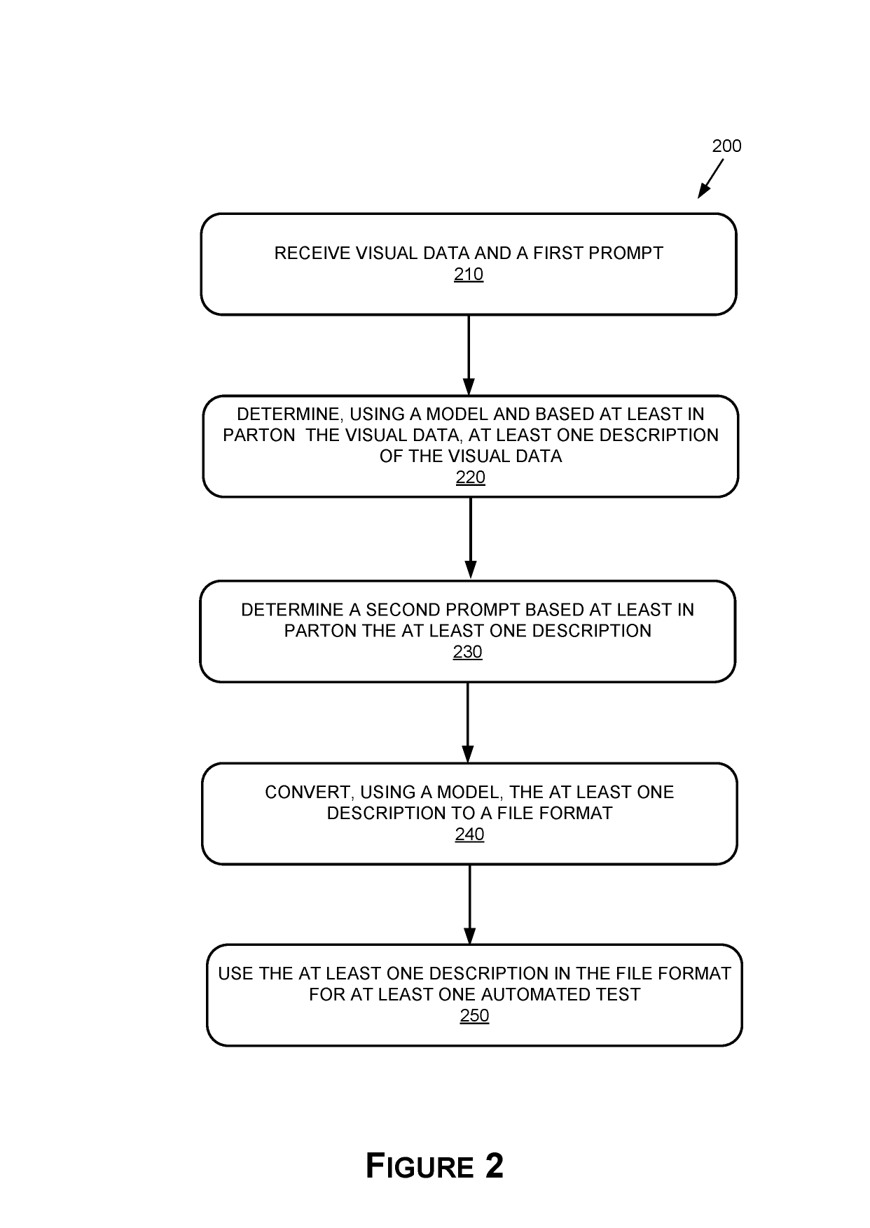

With reference to FIG. 2, an example flow diagram illustrating a method 200 for validating visual data using context-specific prompts and generating structured outputs in an example pipeline (e.g., visual modeling pipeline), in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processors executing instructions stored in one or more memories. For example, in some implementations, the system and methods described herein can be implemented using one or more generative language models (e.g., as described in FIGS. 4A-4C), one or more computing devices or components thereof (e.g., as described in FIG. 5), and/or one or more data centers or components thereof (e.g., as described in FIG. 6).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for validating visual data using context-specific prompts and generating structured outputs in a visual modeling pipeline, in accordance with some implementations of the present disclosure. The method 200, at block 210, includes obtaining, by and/or using a visual language model (VLM) and/or at least one neural network (NN) model, visual data and a first prompt corresponding to a context of the visual data. That is, the VLM can be configured to process visual and contextual information based at least in part on one or more prompts. Generally, the first prompt can correspond to a parameter of a visual testing framework corresponding to a feature (e.g., object presence, environmental attributes, spatial relationships) or condition (e.g., lighting variations, occlusion scenarios, object placement) to test. That is, the first prompt directs the VLM to focus (e.g., by guiding attention mechanisms to prioritize regions of the image, identifying objects or features related to the prompt, weight visual data) on specific aspects of the visual data for analysis. For example, the prompt can query whether specific objects are present in a scene or if environmental conditions match expectations. The VLM can obtain and/or receive the visual data and first prompt from a data source, such as an input system or a preprocessed data handler. The visual data can be at least one of (i) a generated image or video, (ii) a captured image or video, (iii) a composite image from a plurality of image sources, and/or (iv) a sequence of visual frames. The context-specific prompt can be used to guide the VLM in validating. For example, the prompt can instruct the VLM to verify object alignment or identify specific elements based at least in part on the scenario.

The method 200, at block 220, includes determining, using the VLM and/or the at least one neural network model and based at least in part on the visual data and/or first prompt, at least one description of the visual data. That is, the VLM can be used to analyze the visual data (in regards to the prompt) to generate a descriptive output that captures relevant features or attributes. For example, the visual data and/or the prompt can be inputted into the VLM. In this example, the VLM can output a detailed description of detected objects, corresponding positions, and other contextual attributes. In some implementations, determining the at least one description of the visual data can include extracting, by the VLM, the one or more attributes from the visual data using multimodal feature extraction. The multimodal feature extraction (e.g., using visual patterns with contextual information, using cross-modal attention, using embeddings to correlate features across modalities) can correspond to extracting visual and textual elements based at least in part on the first prompt. For example, the processing circuits can process combined visual and textual inputs to generate structured descriptions. In another example, the processing circuits can identify correlations between visual features and the context provided in the prompt. Additionally, the at least one description can include one or more attributes detected within the visual data. That is, the one or more attributes can include at least one of an object identification (e.g., object type, object class), a spatial orientation (e.g., location coordinates, spatial configuration), or an environmental parameter (e.g., illumination levels, background features). For example, the descriptive output can include a list of detected objects and corresponding spatial relationships. In another example, the descriptive output can include environmental conditions relevant to the visual scene.

The method 200, at block 230, includes determining a second prompt based at least in part on the at least one description. In some implementations, the second prompt can be determined based at least in part on the at least one description and a skeletal JSON. That is, the initial visual descriptions can be used to create a second prompt to facilitate the generation of a structured output (e.g., satisfying a structured template). For example, the second prompt can organize the extracted attributes into a format specified by a predefined schema. In another example, the second prompt can guide further analysis by identifying additional parameters or conditions for validation. In some implementations, the processing circuits can determine the second prompt by mapping the detected attributes to the corresponding fields in the skeletal JSON. That is, the second prompt can be structured to fill in the fields based at least in part on the initial descriptions. For example, the second prompt can include fields like {‘objectDetected’: Boolean, ‘spatialConsistency’: Boolean} based at least in part on the initial analysis.

The method 200, at block 240, includes converting, using a large language model (LLM) and/or at least one NN model, the at least one description to a file format. In some implementations, method 200 includes generate, using the at least one NN model, a structured format for the at least one description. That is, the processing circuits can transform the generated description into a structured format (e.g., JSON, XML, YAML). The structured format can be used in subsequent automated testing (e.g., validating expected values, verifying attribute presence, checking data consistency). That is, the LLM can be used to interpret the descriptive output and generate structured data. For example, converting can include the LLM populating a JSON object based at least in part on detected attributes and corresponding values. In this example, the processing circuits can map the detected features into the predefined fields of the structured format. In another example, converting can include the LLM transforming the descriptive information into a machine-readable format for automated validation. In this example, the processing circuits can translate the descriptions into structured templates for further processing and/or testing. In some implementations, converting (e.g., using the LLM) can include mapping the one or more attributes of the at least one description into a structured data format compatible with a testing system. That is, the processing circuits can verify that the structured data aligns with the requirements of the automated testing framework. For example, the processing circuits can format the attributes and corresponding values into a schema compatible with the testing systems and/or validation tools.

The method 200, at block 250, includes using the at least one description in the file format for at least one automated test. That is, the processing circuits can use at least a portion of the structured format for at least one automated test associated with the visual data. In some implementations, the processing circuits can apply at least a portion of the file format in at least one automated test associated with the visual data. In some implementations, automated tests can include attribute validation, consistency checks, scenario-based testing, integration tests, compliance verification, performance benchmarking, and/or any visual data analysis actions. Generally, using can refer to the processing circuits executing predefined test scripts or procedures based at least in part on the structured data. In some implementations, the processing circuits can execute an application to perform automated testing. That is, using the description in the file format can include executing automated tests to verify the correctness of visual attributes against predefined scenarios. For example, an automated test can validate the presence of specific visual elements or check for conformity to expected configurations. In another example, an automated test can benchmark visual performance metrics against thresholds.

The method 200 can further include receiving, by the VLM, a subsequent prompt to validate the one or more attributes within the visual data. That is, the prompt can request a validation of details of the visual content or scenarios during testing. For example, the prompt can query whether detected attributes match the expected results or if specific conditions are met. Additionally, the processing circuits can generate (e.g., by the VLM) a corresponding validation output. In some implementations, the corresponding validation output can include at least one of a pass-fail result, a confidence score, or an interpretation of the corresponding validation output. For example, the output can indicate whether the test passed, the level of certainty, or an explanation of discrepancies. In some implementations, the subsequent prompt can be structured to query the one or more attributes of the visual data. For example, the structure of the subsequent prompt can be based at least in part on the initial prompt and the outcomes of previous tests. In this example, the structure can query various details, such as, but not limited to, object attributes, spatial consistency, and/or scene characteristics (e.g., an attribute of the visual data).

Disclosed implementations can be included in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA’s OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), neural representation techniques, diffusion models, transformer models, etc.), systems implemented at least partially in a data center, systems for performing conversational AI operations, systems implementing one or more language models - such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

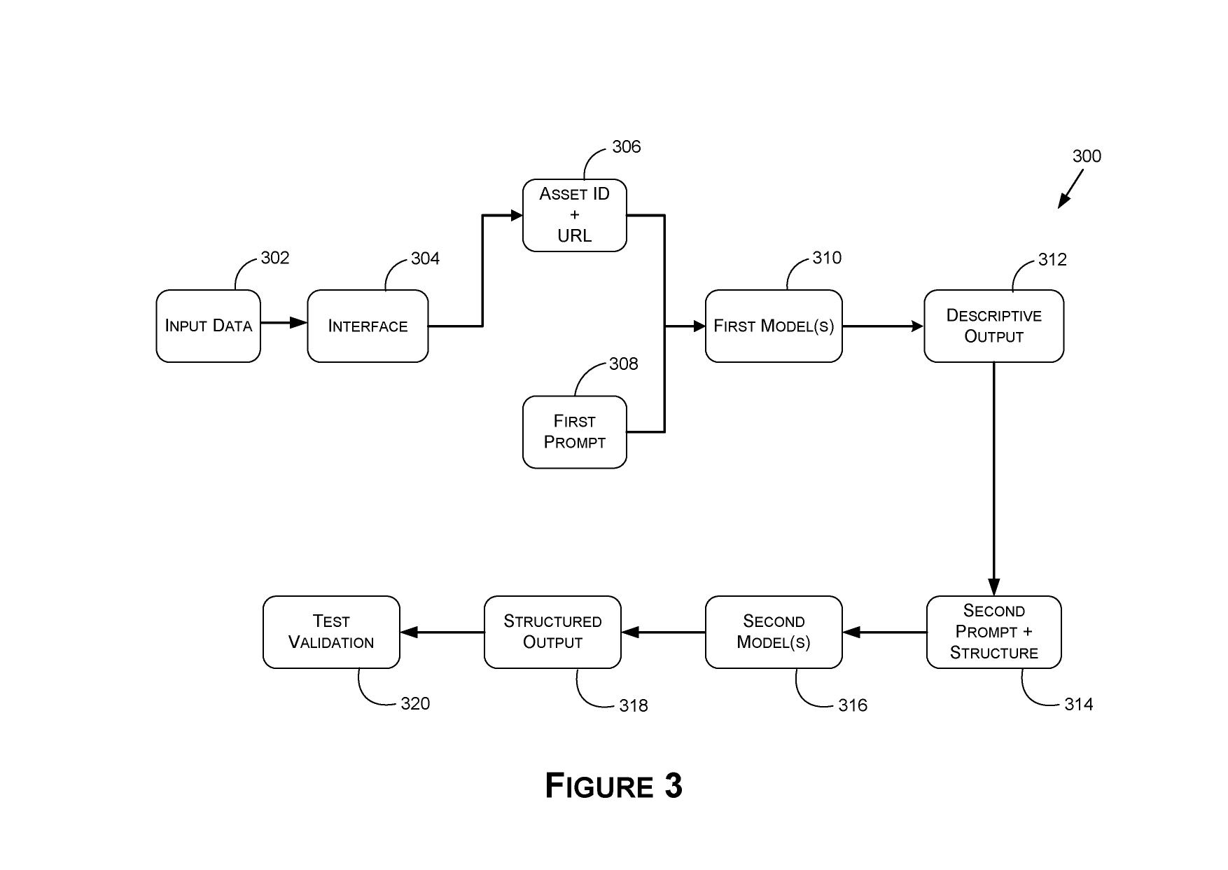

With reference to FIG. 3, a block diagram of the example pipeline 300, in accordance with some implementations of the present disclosure. In some implementations, the input data at block 302 (e.g., from source 104) can be obtained and/or received by an application programming interface (API) and/or data handler to preprocess the visual data for subsequent analysis. For example, the data handler can receive and structure input formats for compatibility with downstream components. In another example, the API can standardize input formats and restrict (e.g., limit and/or filter) visual data based at least in part on predefined constraints or requirements (e.g., size limits, data format constraints, resolution parameters, frame rate thresholds). That is, the interface at block 304 (e.g., data preprocessor 108) can manage data flow within the visual modeling pipeline. The asset ID and URL at block 306 can be used to tag and track visual data within the system. In some implementations, the input data can be identified by metadata attributes, such as timestamps or source identifiers. For example, a portion of the visual data can be associated with a specific test scenario. In another example, the image and/or video (or multimedia) can be linked to test case identifiers.

Additionally, a first prompt can be generated at block 308 (e.g., by prompt generator 112). In some implementations, the first prompt can provide context for modeling visual elements. For example, the prompt can request validation of scene elements or object presence. At block 310, the first model (e.g., model 116) can model (e.g., using a VLM) the visual data based at least in part on the first prompt to generate a descriptive output. In some implementations, the first model can generate descriptions correlating to the context of the prompt. That is, the model can provide descriptive outputs having visual attributes and/or contextual information. For example, the first model can generate a descriptive output identifying detected objects based at least in part on the first prompt. The descriptive output at block 312 can include specific features and relationships within the visual data as interpreted by the first model. In some implementations, the descriptive output can include information such as object presence, spatial configurations, and/or scene characteristics. That is, the output can be used for generating structured data in subsequent stages.

Additionally, a second prompt with a corresponding structure can be generated at block 314 (e.g., by prompt generator 120). In some implementations, the second prompt can refine or expand the initial descriptions into a structured format, such as JSON, based at least in part on a skeletal template. That is, the prompt generator can organize descriptive attributes into a data structure. For example, the second prompt can define how to map attributes into fields (e.g., {‘fog’: Boolean, ‘SenseOfDepth’: Boolean}). The second model (e.g., model 124, such as an LLM) at block 316 can convert the descriptive output into a structured format compatible with one or more automated testing systems. In some implementations, the second model can use the structured prompt to generate a machine-readable data representation. That is, the model can perform data transformation into a structured output. For example, the second model can map descriptive attributes into predefined fields (e.g., aligning with test requirements).

As shown, the structured output at block 318 can be used for automated validation against expected outcomes. In some implementations, the structured output can be verified to ensure it captures details for validation. That is, the structured output can provide input for automated test validation processes. For example, the structured output can include attributes and data, formatted for use in testing applications. At block 320, testing validation (e.g., pass/fail evaluation, compliance verification) can be performed on the structured output (e.g., by application 128). In some implementations, testing validation can include comparing the structured output against predefined criteria or scenarios. That is, the structured data can be analyzed to verify alignment with expected outcomes or specifications. For example, testing validation can include checking for the presence of required attributes, verifying attribute values, and/or confirming consistency with the initial prompt context.

### EXAMPLE LANGUAGE MODELS

In at least some implementations, language models, such as large language models (LLMs), vision language models (VLMs), multi-modal language models (MMLMs), and/or other types of generative artificial intelligence (AI) can be implemented. Generally, the language models can process and analyze both visual and textual data to generate descriptive outputs, predictions, or structured formats based at least in part on prompts or context. That is, the models can integrate multiple data modalities, such as images and text, to perform tasks or actions, such as object recognition, scene analysis, and content generation in an automated testing or validation environment. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least in part on the context provided in input prompts or queries. These language models can be considered “large,” in implementations, based at least in part on the models being trained on massive datasets and having architectures with large number of learnable network parameters (weights and biases)—such as millions or billions of parameters. The LLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/VLMs/MMLMs/etc. can also include one or more diffusion block(s) (e.g., denoisers). The LLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/VLMs/MMLMs/etc.

In various implementations, the LLMs/VLMs/MMLMs/etc. can be trained using unsupervised learning, in which an LLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least in part on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 4A is a block diagram of an example generative language model system 400 suitable for use in implementing at least some implementations of the present disclosure. Generally, the example generative language model system 400 can process input data, such as text or visual information, to generate outputs based at least in part on context-specific prompts or instructions. That is, the system can utilize generative language models to create descriptive outputs, structured data formats, and/or perform predictions by analyzing the input and applying learned patterns from previous training data. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which can include an LLM, a VLM, a multi-modal LM, etc.).

At a high level, the input processor 405 can receive an input 401 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 430 (e.g., LLM/VLM/MMLM/etc.). In some implementations, the input 401 includes plain text in the form of one or more sentences, paragraphs, and/or documents. Additionally or alternatively, the input 401 can include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 can combine text (or can omit text) with image data, audio data, video data, design data, USD data, and/or other types of input data, such as but not limited to those described herein. Taking raw input text as an example, the input processor 405 can prepare raw input text in various ways. For example, the input processor 405 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 can remove stopwords to reduce noise and focus the generative LM 430 on more meaningful content. The input processor 405 can apply text normalization, for example, by converting all characters to lowercase, removing accents, and/or or handling special cases like contractions or abbreviations to ensure consistency. These are just a few examples, and other types of input processing can be applied.

In some implementations, a RAG component 492 (which can include one or more RAG models, and/or can be performed using the generative LM 430 itself) can be used to retrieve additional information to be used as part of the input 401 or prompt. RAG can be used to enhance the input to the LLM/VLM/MMLM/etc. with external knowledge, so that answers to specific questions or queries or requests are more relevant—such as in a case where specific knowledge is required. The RAG component 492 can fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some implementations, the input 401 can be generated using the query or input to the model (e.g., a question, a request, etc.) in addition to data retrieved using the RAG component 492. In some implementations, the input processor 405 can analyze the input 401 and communicate with the RAG component 492 (or the RAG component 492 can be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 can retrieve a prior stored conversation history—or at least a summary thereof—and include the prior conversation history along with the current ask/request as part of the input 401 to the generative LM 430.

The RAG component 492 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 492 and the embeddings of the chunks along with the embeddings of the query can be compared to identify the most similar/related embeddings to the query, which can be supplied to the generative LM 430 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLM/VLM/MMLM/etc. Rather than (or in addition to) providing the model with chunks of data extracted from larger sized documents—which can result in a lack of context, factual correctness, language accuracy, etc.—graph RAG can also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLM/VLM/MMLM/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 492 can implement a plugin, API, user interface, and/or other functionality to perform RAG. For example, a graph RAG plug-in can be used by the LLM/VLM/MMLM/etc. to run queries against the knowledge graph to extract relevant information for feeding to the model, and a standard or vector RAG plug-in can be used to run queries against a vector database. For example, the graph database can interact with a plug-in’s REST interface such that the graph database is decoupled from the vector database and/or the embeddings models.

The tokenizer 410 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy can depend on factors such as the language being processed, the task at hand, and/or characteristics of the training dataset. As such, the tokenizer 410 can convert the (e.g., processed) text into a structured format according to tokenization schema being implemented in the particular implementation.

The embedding component 420 can use any known embedding technique to transform discrete tokens into (e.g., dense, continuous vector) representations of semantic meaning. For example, the embedding component 420 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 can resize the data to a standard size compatible with format of a corresponding input channel and/or can normalize pixel values to a common range (e.g., 0 to 1) to ensure a consistent representation, and the embedding component 420 can encode the image data using any known technique (e.g., using one or more convolutional neural networks (CNNs) to extract visual features). In some implementations in which the input 401 includes audio data, the input processor 401 can resample an audio file to a consistent sampling rate for uniform processing, and the embedding component 420 can use any known technique to extract and encode audio features—such as in the form of a spectrogram (e.g., a mel-spectrogram). In some implementations in which the input 401 includes video data, the input processor 401 can extract frames or apply resizing to extracted frames, and the embedding component 420 can extract features such as optical flow embeddings or video embeddings and/or can encode temporal information or sequences of frames. In some implementations in which the input 401 includes multi-modal data, the embedding component 420 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 can apply an encoded representation of the input 401 to the generative LM 430, and the generative LM 430 can process the encoded representation of the input 401 to generate an output 490, which can include responsive text and/or other types of data.

As described herein, in some implementations, the generative LM 430 can be configured to access or use—or capable of accessing or using—plug-ins/APIs 495 (which can include one or more plug-ins, application programming interfaces (APIs), databases, data stores, repositories, etc.). For example, for certain tasks or operations that the generative LM 430 is not ideally suited for, the model can have instructions (e.g., as a result of training, and/or based at least in part on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 495 to the plug-in/API 495, the plug-in/API 495 can process the information and return an answer to the generative LM 430, and the generative LM 430 can use the response to generate the output 490. This process can be repeated—e.g., recursively—for any number of iterations and using any number of plug-ins/APIs 495 until an output 490 that addresses each ask/question/request/process/operation/etc. from the input 401 can be generated. As such, the model(s) can not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. Generally, the generative LM 430 can process input data using a sequence of layers to encode information and generate relevant outputs through decoding, based at least in part on the input and prompt. That is, the transformer architecture can capture relationships within the data, allowing for tasks such as text generation, translation, or structured data creation based at least in part on the encoded input. For example, assume input text such as “Who discovered gravity” is tokenized (e.g., by the tokenizer410 of FIG. 4A) into tokens such as words, and each token is encoded (e.g., by the embedding component 420 of FIG. 4A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 440 can convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 can generate a first token, and the generation mechanism 455 can apply the generated token as an input during a second pass. The process can repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 can output some decoded (e.g., vector) representation of the input being applied during a particular pass. The classifier 450 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 can select or sample a word or token based at least in part on a corresponding predicted probability (e.g., select the word with the highest predicted probability) and append it to the output from a previous pass, generating each word or token sequentially. The generation mechanism 455 can repeat the process, triggering successive decoder inputs and corresponding predictions until selecting or sampling a symbol or token that represents the end of the response, at which point, the generation mechanism 455 can output the generated response.

FIG. 4C is a block diagram of an example implementation in which the generative LM 430 includes a decoder-only transformer architecture. For example, the decoder(s) 460 of FIG. 4C can operate similarly as the decoder(s) 445 of FIG. 4B except each of the decoder(s) 460 of FIG. 4C omits the encoder-decoder self-attention layer (since there is no encoder in this implementation). As such, the decoder(s) 460 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 460. As with the decoder(s) 445 of FIG. 4B, each token (e.g., word) can flow through a separate path in the decoder(s) 460, and the decoder(s) 460, a classifier 465, and a generation mechanism 470 can use auto-regression to sequentially generate one token at a time until predicting a symbol or token that represents the end of the response. The classifier 465 and the generation mechanism 470 can operate similarly as the classifier 450 and the generation mechanism 455 of FIG. 4B, with the generation mechanism 470 selecting or sampling each successive output token based at least in part on a corresponding predicted probability and appending it to the output from a previous pass, generating each token sequentially until selecting or sampling a symbol or token that represents the end of the response. Generally, the generative LM 430 can process input data by generating sequential outputs based at least in part on a context or prompt. That is, the model can generate at least one (e.g., each) token of the output sequentially, utilizing self-attention and feedforward layers to predict the next token in the sequence, until an end token or the completion of the output is reached. These and other architectures described herein are meant simply as examples, and other suitable architectures can be implemented within the scope of the present disclosure.

### EXAMPLE COMPUTING DEVICE

FIG. 5 is a block diagram of an example computing device(s) 500 suitable for use in implementing some implementations of the present disclosure. Generally, the example computing device(s) 500 can facilitate the processing, analysis, and/or management of visual and contextual data within the visual modeling pipeline. That is, the computing device(s) 500 can execute models, process input data, generate structured outputs, and/or perform automated validation in accordance with the disclosed implementations. Computing device 500 can include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 can comprise one or more virtual machines (VMs), and/or any of the components thereof can comprise virtual components (e.g., virtual hardware components). For non-limiting examples, one or more of the GPUs 508 can comprise one or more vGPUs, one or more of the CPUs 506 can comprise one or more vCPUs, and/or one or more of the logic units 520 can comprise one or more virtual logic units. As such, a computing device(s) 500 can include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, can be considered an I/O component 514 (e.g., if the display is a touch screen). As another example, the CPUs 506 and/or GPUs 508 can include memory (e.g., the memory 504 can be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 can represent one or more links or busses, such as an address bus, a data bus, a control bus, or a combination thereof. The interconnect system 502 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 can be directly connected to the memory 504. Further, the CPU 506 can be directly connected to the GPU 508. Where there is direct, or point-to-point connection between components, the interconnect system 502 can include a PCIe link to carry out the connection. In these examples, a PCI bus need not be included in the computing device 500.

The memory 504 can include any of a variety of computer-readable media. The computer-readable media can be any available media that can be accessed by the computing device 500. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 504 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 506 can be configured to execute at least some of the computer-readable instructions to control one or more components of the computing device 500 to perform one or more of the methods and/or processes described herein. The CPU(s) 506 can each include one or more cores (e.g., one, two, four, eight, twenty-eight, seventy-two, etc.) that are capable of handling a multitude of software threads simultaneously. The CPU(s) 506 can include any type of processor, and can include different types of processors depending on the type of computing device 500 implemented (e.g., processors with fewer cores for mobile devices and processors with more cores for servers). For example, depending on the type of computing device 500, the processor can be an Advanced RISC Machines (ARM) processor implemented using Reduced Instruction Set Computing (RISC) or an x86 processor implemented using Complex Instruction Set Computing (CISC). The computing device 500 can include one or more CPUs 506 in addition to one or more microprocessors or supplementary co-processors, such as math co-processors.

In addition to or alternatively from the CPU(s) 506, the GPU(s) 508 can be configured to execute at least some of the computer-readable instructions to control one or more components of the computing device 500 to perform one or more of the methods and/or processes described herein. One or more of the GPU(s) 508 can be an integrated GPU (e.g., with one or more of the CPU(s) 506 and/or one or more of the GPU(s) 508 can be a discrete GPU. In implementations, one or more of the GPU(s) 508 can be a coprocessor of one or more of the CPU(s) 506. The GPU(s) 508 can be used by the computing device 500 to render graphics (e.g., 3D graphics) or perform general purpose computations. For example, the GPU(s) 508 can be used for General-Purpose computing on GPUs (GPGPU). The GPU(s) 508 can include hundreds or thousands of cores that are capable of handling hundreds or thousands of software threads simultaneously. The GPU(s) 508 can generate pixel data for output images in response to rendering commands (e.g., rendering commands from the CPU(s) 506 received via a host interface). The GPU(s) 508 can include graphics memory, such as display memory, for storing pixel data or any other suitable data, such as GPGPU data. The display memory can be included as part of the memory 504. The GPU(s) 508 can include two or more GPUs operating in parallel (e.g., via a link). The link can directly connect the GPUs (e.g., using NVLINK) or can connect the GPUs through a switch (e.g., using NVSwitch). When combined together, each GPU 508 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 506 and/or the GPU(s) 508, the logic unit(s) 520 can be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 can discretely or jointly perform any combination of the methods, processes and/or portions thereof. One or more of the logic units 520 can be part of and/or integrated in one or more of the CPU(s) 506 and/or the GPU(s) 508 and/or one or more of the logic units 520 can be discrete components or otherwise external to the CPU(s) 506 and/or the GPU(s) 508. In implementations, one or more of the logic units 520 can be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 can include one or more receivers, transmitters, and/or transceivers that allow the computing device 500 to communicate with other computing devices via an electronic communication network, included wired and/or wireless communications. The communication interface 510 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 can include one or more data processing units (DPUs) to transmit data received over a network and/or through interconnect system 502 directly to (e.g., a memory of) one or more GPU(s) 508.

The I/O ports 512 can allow the computing device 500 to be logically coupled to other devices including the I/O components 514, the presentation component(s) 518, and/or other components, some of which can be built in to (e.g., integrated in) the computing device 500. Illustrative I/O components 514 include a microphone, mouse, keyboard, joystick, game pad, game controller, satellite dish, scanner, printer, wireless device, etc. The I/O components 514 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 can be include depth cameras, such as stereoscopic camera systems, infrared camera systems, RGB camera systems, touchscreen technology, and combinations of these, for gesture detection and recognition. Additionally, the computing device 500 can include accelerometers or gyroscopes (e.g., as part of an inertia measurement unit (IMU)) that allow detection of motion. In some examples, the output of the accelerometers or gyroscopes can be used by the computing device 500 to render immersive augmented reality or virtual reality.

The power supply 516 can include a hard-wired power supply, a battery power supply, or a combination thereof. The power supply 516 can provide power to the computing device 500 to allow the components of the computing device 500 to operate.

The presentation component(s) 518 can include a display (e.g., a monitor, a touch screen, a television screen, a heads-up-display (HUD), other display types, or a combination thereof), speakers, and/or other presentation components. The presentation component(s) 518 can receive data from other components (e.g., the GPU(s) 508, the CPU(s) 506, DPUs, etc.), and output the data (e.g., as an image, video, sound, etc.).

### EXAMPLE DATA CENTER

FIG. 6 illustrates an example data center 600 that can be used in at least one implementations of the present disclosure. Generally, the example data center 600 can support the processing, storage, and management of large-scale visual data used in automated validation and analysis tasks. That is, the data center can facilitate the computational processes involved in running visual language models (VLMs) and generating structured outputs for automated testing. The data center 600 can include a data center infrastructure layer 610, a framework layer 620, a software layer 630, and/or an application layer 640.

As shown in FIG. 6, the data center infrastructure layer 610 can include a resource orchestrator 612, grouped computing resources 614, and node computing resources (“node C.R.s”) 616(1)-616(N), where “N” represents any whole, positive integer. In at least one implementation, node C.R.s 616(1)-616(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) can correspond to a server having one or more of the above-mentioned computing resources. In addition, in some implementations, the node C.R.s 616(1)-6161(N) can include one or more virtual components, such as vGPUs, vCPUs, and/or the like, and/or one or more of the node C.R.s 616(1)-616(N) can correspond to a virtual machine (VM).

In at least one implementation, grouped computing resources 614 can include separate groupings of node C.R.s 616 housed within one or more racks (not shown), or many racks housed in data centers at various geographical locations (also not shown). Separate groupings of node C.R.s 616 within grouped computing resources 614 can include grouped compute, network, memory or storage resources that can be configured or allocated to support one or more workloads. In at least one implementation, several node C.R.s 616 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 612 can configure or otherwise control one or more node C.R.s 616(1)-616(N) and/or grouped computing resources 614. In at least one implementation, resource orchestrator 612 can include a software design infrastructure (SDI) management entity for the data center 600. The resource orchestrator 612 can include hardware, software, or some combination thereof.

In at least one implementation, as shown in FIG. 6, framework layer 620 can include a job scheduler 628, a configuration manager 634, a resource manager 636, and/or a distributed file system 638. The framework layer 620 can include a framework to support software 632 of software layer 630 and/or one or more application(s) 642 of application layer 640. The software 632 or application(s) 642 can respectively include web-based service software or applications, such as those provided by Amazon Web Services, Google Cloud and Microsoft Azure. The framework layer 620 can be, but is not limited to, a type of free and open-source software web application framework such as Apache Spark^{TM} (hereinafter “Spark”) that can use distributed file system 638 for large-scale data processing (e.g., “big data”). In at least one implementation, job scheduler 628 can include a Spark driver to facilitate scheduling of workloads supported by various layers of data center 600. The configuration manager 634 can be capable of configuring different layers such as software layer 630 and framework layer 620 including Spark and distributed file system 638 for supporting large-scale data processing. The resource manager 636 can be capable of managing clustered or grouped computing resources mapped to or allocated for support of distributed file system 638 and job scheduler 628. In at least one implementation, clustered or grouped computing resources can include grouped computing resource 614 at data center infrastructure layer 610. The resource manager 636 can coordinate with resource orchestrator 612 to manage these mapped or allocated computing resources.

In at least one implementation, software 632 included in software layer 630 can include software used by at least portions of node C.R.s 616(1)-616(N), grouped computing resources 614, and/or distributed file system 638 of framework layer 620. One or more types of software can include, but are not limited to, Internet web page search software, e-mail virus scan software, database software, and streaming video content software.

In at least one implementation, application(s) 642 included in application layer 640 can include one or more types of applications used by at least portions of node C.R.s 616(1)-616(N), grouped computing resources 614, and/or distributed file system 638 of framework layer 620. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 can implement any number and type of self-modifying actions based at least in part on any amount and type of data acquired in any technically feasible fashion. Self-modifying actions can relieve a data center operator of data center 600 from making possibly bad configuration decisions and possibly avoiding underutilized and/or poor performing portions of a data center.

The data center 600 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 600. In at least one implementation, trained or deployed machine learning models corresponding to one or more neural networks can be used to infer or predict information using resources described above with respect to the data center 600 by using weight parameters calculated through one or more training techniques, such as but not limited to those described herein.

In at least one implementation, the data center 600 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### EXAMPLE NETWORK ENVIRONMENTS

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 500 of FIG. 5—e.g., each device can include similar components, features, and/or functionality of the computing device(s) 500. In addition, where backend devices (e.g., servers, NAS, etc.) are implemented, the backend devices can be included as part of a data center 600, an example of which is described in more detail herein with respect to FIG. 6.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 500 described herein with respect to FIG. 5. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. A system, comprising:
one or more processors to execute one or more operations comprising:
obtain, by a visual language model (VLM), visual data and a first prompt corresponding to a context of the visual data;
determine, using the VLM and based at least in part on the visual data, at least one description of the visual data;
determine a second prompt based at least in part on the at least one description;
convert, using a large language model (LLM), the at least one description to a file format; and
use the at least one description in the file format for at least one automated test.

2. The system of claim 1, wherein the visual data comprises at least one of (i) a generated image or video, (ii) a captured image or video, (iii) a composite image from a plurality of image sources, or (iv) a sequence of visual frames.

3. The system of claim 1, wherein the one or more operations to determine the second prompt is based at least in part on the at least one description and a skeletal JSON, and wherein the first prompt corresponds to a parameter of a visual testing framework corresponding to a feature or condition to test.

4. The system of claim 1, wherein the file format is JSON format, and wherein at least one description comprises one or more attributes detected within the visual data, the one or more attributes comprising at least one of an object identification, a spatial orientation, or an environmental parameter.

5. The system of claim 4, wherein the one or more operations further comprise at least one operation to:
receive, by the VLM, a subsequent prompt to validate the one or more attributes within the visual data;
generate, by the VLM, a corresponding validation output.

6. The system of claim 5, wherein the corresponding validation output comprises at least one of a pass-fail result, a confidence score, or an interpretation of the corresponding validation output, and wherein the subsequent prompt is structured to query the one or more attributes of the visual data.

7. The system of claim 4, wherein the one or more operations to determine the at least one description of the visual data further comprises:
extracting, by the VLM, the one or more attributes from the visual data using multimodal feature extraction corresponding with visual and textual elements based at least on in part on the first prompt.

8. The system of claim 4, wherein the one or more operations to convert using the LLM further comprises:
mapping the one or more attributes of the at least one description into a structured data format compatible with a testing system.

9. The system of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing small language models (SLMs);
a system implementing multi-modal language models;
a system for hosting one or more real-time streaming applications;
a system for performing light transport simulation;
a system for performing collaborative content creation for 3D assets; or
a system implemented at least partially using cloud computing resources.

10. One or more processors, comprising:
one or more processing circuits to:
obtain, by at least one neural network (NN) model, visual data and a first prompt corresponding to a context of the visual data;
determine, using the at least one NN model and based at least on the first prompt, at least one description of the visual data;
determine a second prompt based at least in part on the at least one description;
generate, using the at least one NN model, a structured format for the at least one description; and
use at least a portion of the structured format for at least one automated test associated with the visual data.

11. The one or more processors of claim 10, wherein the visual data comprises at least one of:
a generated image or video;
a captured image or video;
a composite image from a plurality of image sources; or
a sequence of visual frames.

12. The one or more processors of claim 10, wherein the second prompt is determined based at least in part on the at least one description and a skeletal JSON, and wherein the first prompt corresponds to a parameter of a visual testing framework corresponding to a feature or condition to test.

13. The one or more processors of claim 10, wherein the structured format is JSON format, and wherein at least one description comprises one or more attributes detected within the visual data, the one or more attributes comprising at least one of an object identification, a spatial orientation, or an environmental parameter.

14. The one or more processors of claim 13, wherein the one or more processing circuits are to:
receive, by the at least one NN model, a subsequent prompt to validate the one or more attributes within the visual data;
generate, by the at least one NN model, a corresponding validation output.

15. The one or more processors of claim 14, wherein the corresponding validation output comprises at least one of a pass-fail result, a confidence score, or an interpretation of the corresponding validation output, and wherein the subsequent prompt is structured to query the one or more attributes of the visual data.

16. The one or more processors of claim 13, wherein determining the at least one description of the visual data further comprises:
extracting, by the at least one NN model, the one or more attributes from the visual data using multimodal feature extraction corresponding with visual and textual elements based at least on in part on the first prompt.

17. The one or more processors of claim 13, wherein converting using the at least one NN model further comprises:
mapping the one or more attributes of the at least one description into a structured data format compatible with a testing system.

18. A method, comprising:
determining, using at least one neural network (NN) model and based at least in part on a first prompt corresponding to visual data, at least one description of the visual data;
determining a second prompt based at least in part on the at least one description;
converting, using the at least one NN model, the at least one description to a file format; and
applying at least a portion of the file format in at least one automated test associated with the visual data.

19. The method of claim 18, wherein the visual data comprises at least one of:
a generated image or video;
a captured image or video;
a composite image from a plurality of image sources; or
a sequence of visual frames.

20. The method of claim 18, wherein the second prompt is determined based at least in part on the at least one description and a skeletal template, and wherein the first prompt corresponds to a parameter of a visual testing framework corresponding to a feature or condition to test.
